(19) United States
(12) Patent Application Publication
(10) Pub. No.: US 2022/0164826 A1
(43) Pub. Date: May 26, 2022

(54) SOCIAL MEDIA AI MITIGATION AND MASKING

(71) Applicant: Cisco Technology, Inc., San Jose, CA (US)

(72) Inventors: M. David Hanes, Lewisville, NC (US); Gonzalo Salgueiro, Raleigh, NC (US); Sebastian Jeuk, Munich (DE); Robert E. Barton, Richmond (CA); Nassim Benoussaid, Louvain-La-Neuve (BE)

(21) Appl. No.: 17/105,031

(22) Filed: Nov. 25, 2020

(51) Int. Cl. G06Q 30/02; G06Q 50/00; G06N 20/00

(52) U.S. Cl. CPC G06Q 30/0255; G06Q 30/0277; G06N 20/00; G06Q 50/01

(57) ABSTRACT

In one embodiment, a device obtains content data provided by a social media platform to a user of the social media platform. The social media platform selects the content data for the user based on a behavioral model of the user. The device maintains an artificial intelligence-based model that models associations between the content data and interaction data indicative of interactions between the user and the social media platform. The device selects, using the artificial intelligence-based model, an obfuscation action to lower an accuracy of the behavioral model of the user, based on one or more configuration parameters set by the user. The device initiates performance of the obfuscation action.

### TECHNICAL FIELD

The present disclosure relates generally to computer networks, and, more particularly, to social media artificial intelligence (AI) mitigation and masking.

### BACKGROUND

Social media platforms are increasingly using artificial intelligence (AI) to profile their users. Indeed, some social media platforms are now leveraging AI to maximize the amount of time that their users spend on their platforms, based on their profile information. By using AI to constantly learn the profile of a user, such as their interests, demographics, etc., a social media platform can tailor the content provided to the user, to keep the user interacting with the social media platform.

Some users of social media platforms are now becoming aware of how much profiling is actually done by social media platforms and are not happy about it. For instance, “The Social Dilemma” is a recent docudrama that that exposes how AI used by large social media platforms can lead to their users becoming addicted to using the platforms. As AI techniques become more powerful, the potential for social media addiction continues to grow.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of a social media platform using artificial intelligence (AI);

FIG. 4 illustrates an example architecture for defending against the use of AI by a social media platform; and

FIG. 5 illustrates an example simplified procedure for defending against the use of AI by a social media platform.

### DESCRIPTION OF EXAMPLE EMBODIMENTS

### Overview

According to one or more embodiments of the disclosure, a device obtains content data provided by a social media platform to a user of the social media platform. The social media platform selects the content data for the user based on a behavioral model of the user. The device maintains an artificial intelligence-based model that models associations between the content data and interaction data indicative of interactions between the user and the social media platform. The device selects, using the artificial intelligence-based model, an obfuscation action to lower an accuracy of the behavioral model of the user, based on one or more configuration parameters set by the user. The device initiates performance of the obfuscation action.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

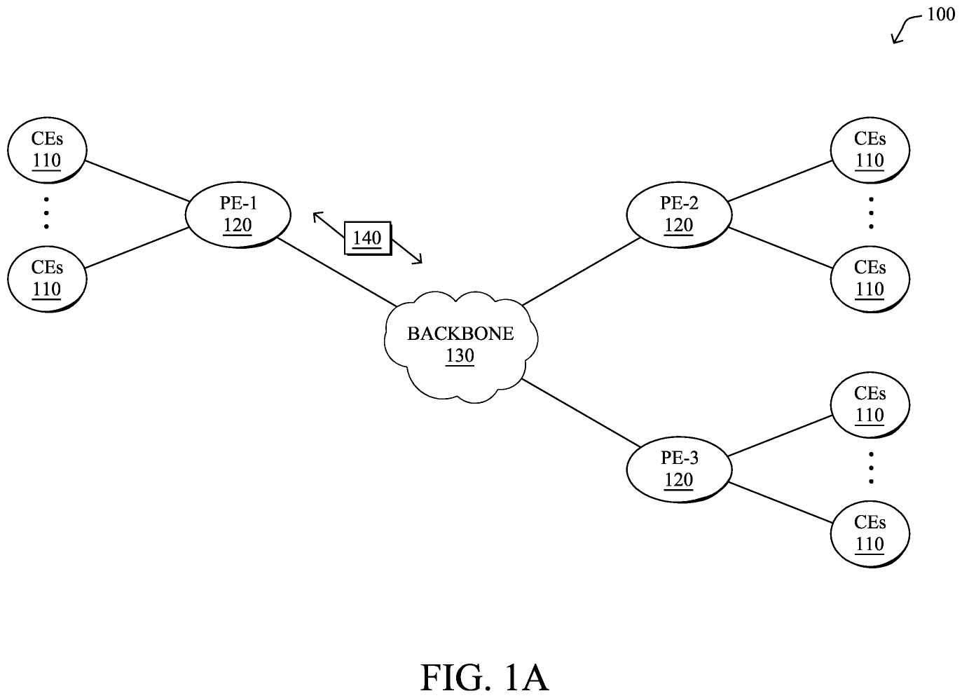

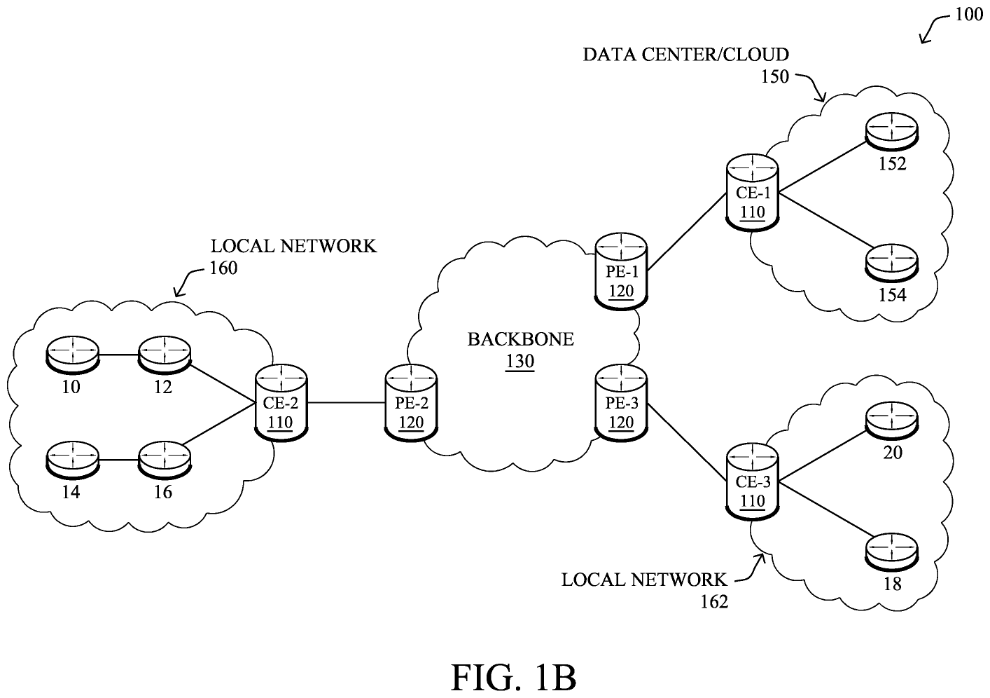

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

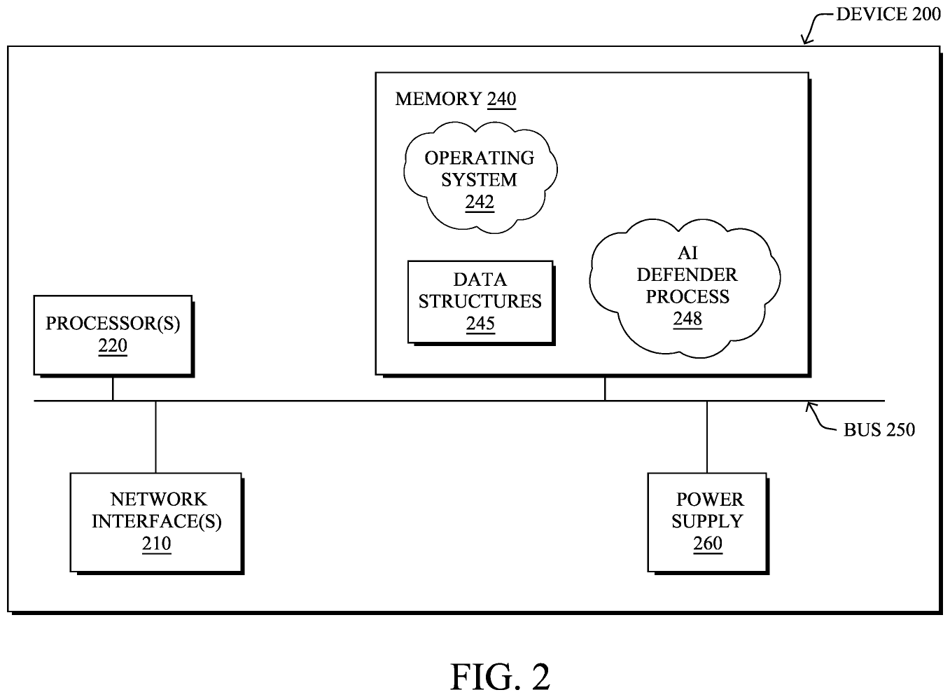

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an artificial intelligence (AI) defender process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, AI defender process 248 may also include computer executable instructions that, when executed by processor(s) 220, cause device 200 to perform the techniques described herein. To do so, in some embodiments, AI defender process 248 may utilize artificial intelligence and, more particularly in some embodiments, machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, AI defender process 248 may employ one or more supervised, unsupervised, or semi-supervised machine learning models. Generally, supervised learning entails the use of a training set of data, as noted above, that is used to train the model to apply labels to the input data. For example, the training data may include samples of interactions between a user and a social media platform and the content that the platform sends to the user. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that AI process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

As noted above, social media platforms are increasingly using AI-based techniques to model the behaviors of their users. This is done, primarily, to tailor the content data that the social media platform to the specific interests and behaviors of the user. However, this can be undesirable for a number of reasons that range from a perceived violation of the privacy of the user to certain users becoming addicted to the social media platform.

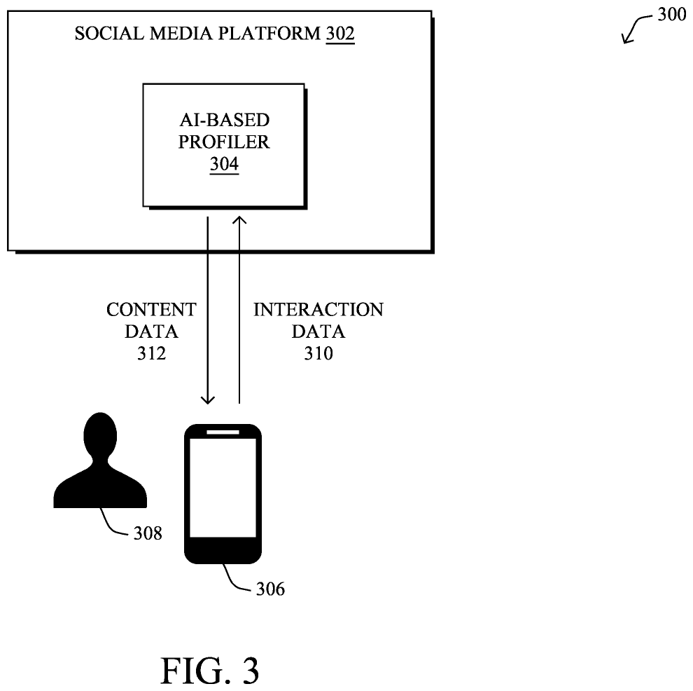

FIG. 3 illustrates an example 300 of a social media platform 302 using AI to profile a user, according to various embodiments. As shown, assume that a user 308 operates an endpoint device 306 to interact with social media platform 302. For instance, endpoint device 306 may be a mobile phone, wearable electronic device, personal computer, tablet or other portable electronic device, or any other form of electronic device able to communicate with social media platform 302 via a network.

In general, social media platform 302 may provide any or all of the following services to its users:
Social networking services the ability for user 308 to form connections with other users of social media platform 302 such as co-workers, family members, friends, etc.
Media sharing services e.g., the ability for user 308 to post media, such as photographs, other images, videos, audio clips, and the like, as well as review media posted by other users of social media platform 302.
Blogging services—e.g., the ability for user 308 to post text, such as status updates, thoughts, opinions, etc., for review by other users of social media platform 302.
Discussion services—e.g., the ability for user 308 and other users of social media platform 302 to collaboratively discuss various topics.
Review services e.g., the ability for user 308 and other users of social media platform 302 to post reviews, such as reviews for restaurants, businesses, products, or the like.

During use, user 308 may operate endpoint device 306 to interact with 302, which provides indications of these interactions to social media platform 302 as interaction data 310. In various embodiments, interaction data 310 may take the form of any or all of the following:
Personal information regarding user 308—e.g., information that user 308 supplies to social media platform 302 to open or update an account, connection information indicative of social relationships between user 308 and other users of social media platform 302 (e.g., following or friending another user, joining a group, or the like), etc.
Content to be shared with other users of social media platform 302 e.g., posted text, video, audio, etc.
Selection of content provided social media platform 302—e.g., playing a particular video or audio clip, clicking a provided link, etc.

According to various embodiments, social media platform 302 may include M-based profiler 304 that is configured to generate and update a behavioral profile for user 308 based on interaction data 310. For instance, if user 308 views a number of videos related to golf, joins an online group devoted to golf, or the like, the behavioral profile for user 308 may indicate that user 308 is interested in the topic of golf.

In some embodiments, AI-based profiler 304 may′ also select content data 312 for user 308 in part on the profile for user 308 that AI-based profiler 304 constructs. For example, if the profile for user 308 indicates that she likes the topic of golf, AI-based profiler 304 may select golf-related content for inclusion in content data 312 sent to endpoint device 306 (e.g., advertisements, suggested media, suggested social groups, etc.).

In further embodiments, AI-based profiler 304 may update its behavioral profile of user 308 over time, as well. For instance, AI-based profiler 304 may also track how user 308 interacts with content data 312 that AI-based profiler 304 selects for user 308, based on interaction data 310. This allows AI-based profiler 304 to adapt to any changing interests of user 308 over time. In addition, this may also allow AI-based profiler 304 to learn and predict how user 308 is likely to interact with various types of content. For instance, AI-based profiler 304 may assess interaction data 310 and content data 312 to predict that user 308 is 97% likely to watch a particular video on golf, should social media platform 302 send it to her.

As would be appreciated, the adaptive and intrusive natures of AI-based profiler 304 may be undesirable to user 308.

### Social Media AI Mitigation and Masking

The techniques herein introduce a defense mechanism that helps to defeat the effects of a social media platform employing AI-based user profiling. In some aspects, a cloud-hosted or locally-hosted defender process may be configured to observe and track how the social medial platform is adapting to the user and manipulating the content that it sends to the user. In further aspects, the defender process may initiate performance of an obfuscation action to help shield the user from the effects of the profiling.

Illustratively, the techniques described herein may be performed by hardware, software, and/or firmware, such as in accordance with the AI defender process 248, which may include computer executable instructions executed by the processor 220 (or independent processor of interfaces 210) to perform functions relating to the techniques described herein.

Specifically, according to various embodiments, a device obtains content data provided by a social media platform to a user of the social media platform. The social media platform selects the content data for the user based on a behavioral model of the user. The device maintains an artificial intelligence-based model that models associations between the content data and interaction data indicative of interactions between the user and the social media platform. The device selects, using the artificial intelligence-based model, an obfuscation action to lower an accuracy of the behavioral model of the user, based on one or more configuration parameters set by the user. The device initiates performance of the obfuscation action.

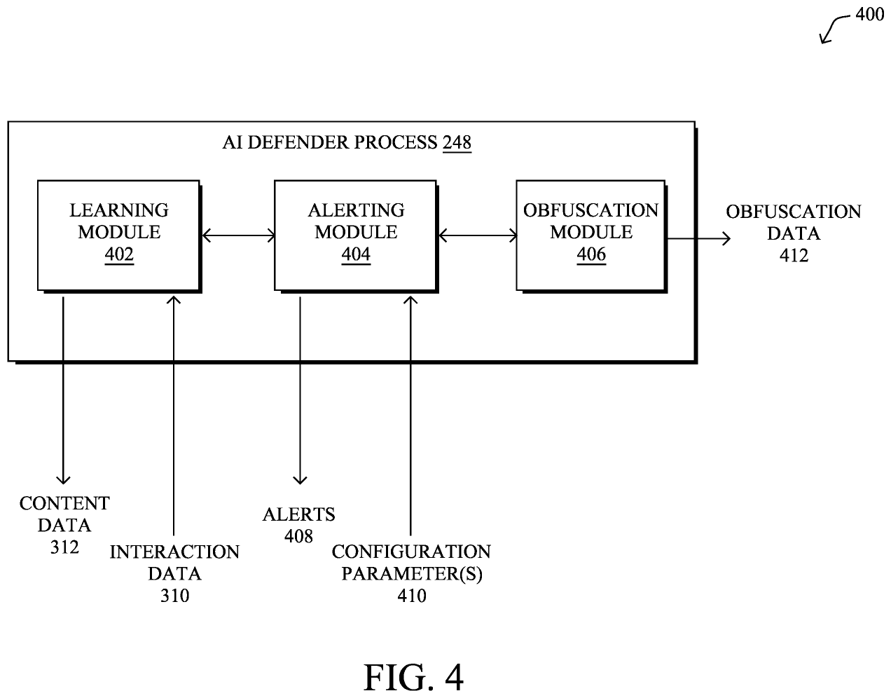

Operationally, FIG. 4 illustrates an example architecture 400 for defending against the use of AI by a social media platform, according to various embodiments. At the core of architecture 400 is AI defender process 248, which may include any or all of the following components: a learning module 402, an alerting module 404, and/or an obfuscation module 406. As would be appreciated, the functionalities of these components may be combined or omitted, as desired. In addition, these components may be implemented on a singular device or in a distributed manner, in which case the combination of executing devices can be viewed as their own singular device for purposes of executing AI defender process 248.

In various embodiments, AI defender process 248 may be executed on an endpoint device operated by a user of a social media platform and/or an intermediate device located between the endpoint device and the social media platform. For instance, AI defender process 248 may be implemented as part of a cloud service that functions as an intermediary between the endpoint device and the social media platform. In another instance, such a cloud service may operate in conjunction with a local module executed by the endpoint device (e.g., a browser plug-in, a watchdog application, etc.). In yet another case, AI defender process 248 may be implemented directly on the endpoint device, to perform the functions herein.

As shown, learning module 402 may be operable to observe/learn from the traffic passed between the endpoint device operated by the user and the social media platform, such as by operating as a proxy service. More specifically, learning module 402 may monitor the feed of content data 312 corning from a social media platform, as well as how the user interacts with the social media service (e.g. mouse clicks, likes, dwell time, and so on), as indicated by interaction data 310. By observing which content data 312 the social media platform presents to the user, as well as how the user interacts with that content, learning module 402 may learn and model these transactions. In other words, learning module 402 may model associations between content data 312 and interaction data 310. This allows learning module 402 to predict how interaction data 310 affects content data 312 that the social media platform provides to the user (e.g., how the social media platform models the behaviors of the user and uses the model to push content to the user).

Once learning module 402 has learned and modeled how the social media platform will respond to the user's interactions with the social media platform, AI defender process 248 can now identify the threats and warn the user. To this end, AI defender process 248 may include alerting module 404 that interacts with the user of the social media platform. For instance, alerting module 404 may provide alerts 408 to the user, to warn the user that the social media platform is manipulating and applying behavioral psychology to the user. By explicitly alerting the user to the manipulation, the user will be better prepared to decide whether to stay engaged with the social media platform.

In some embodiments, alerting module 404 may also receive configuration parameter(s) 410 from the user, allowing the user to specify how AI defender process 248 should operate. For instance, one parameter of configuration parameter(s) 410 may specify the level of sensitivity that AI defender process 248 should employ, before sending alerts 408 to the user.

Depending on the AI approach used by learning module 402, alerting module 404 may also employ different AI techniques when sending alerts 408 to the user. For instance, if learning module 402 uses an interpretable model, such as a Markov Chain, Informational Generative Adversarial Network (InfoGAN), Belief Net, Isolation Forest, or the like, the identification of the variables that lead to a certain classification is straightforward and should perform well for purposes of driving alerts 408. However, when learning module 402 uses a ‘black box’ type of model, such as an ANN, alerting module 404 may employ an explainability tool that decomposes each classification decision by learning module 402, tracing them back to some variables. With these factors identified, alerting module 404 may decide to present them to the user or not via alerts 408, depending on the warning level configured via configuration parameter(s) 410.

In various embodiments, obfuscation module 406 may be operable to generate and send obfuscation data 412 to the social media platform, so as to decrease the accuracy of the behavioral model that the social media platform has for the user. In other words, in some cases, obfuscation module 406 may generate and send obfuscation data 412 to the social networking as false interaction data 310. For instance, if learning module 402 determines that the social medial platform has identified the user as being interested in golf, obfuscation module 406 may send obfuscation data 412 to the social media platform indicative of the user being interested in a different topic (e.g., bowling).

In some cases, obfuscation module 406 may be configurable via configuration parameter(s) 410. For instance, the user may decide between no masking (e.g., obfuscation module 406 not sending any obfuscation data 412) all the way to a complete incognito mode in which obfuscation module 406 inserts random or targeted selections, clicks, likes, etc, into interaction data 310 sent to the social media platform. In one embodiment, the user may specify configuration parameter(s) 410 such that obfuscation data 412 belongs to a certain type or group. In further embodiments, obfuscation module 406 may operate in conjunction with learning module 402 to implement an adversarial machine learning technique intended to defeat the social media platform's behavioral model of the user.

Thus, AI defender process 248 may be configured to initiate any number of obfuscation actions intended to defeat the behavioral profiling by the social media platform. In one embodiment, this may entail alerts 408 specifying an obfuscation action to be performed by the user. For instance, alerts 408 may instruct the user to flush/clear a browser cache or other application cache, resetting an advertising identifier (ID) of their endpoint device, or the like. In other cases, AI defender process 248 may perform these actions, automatically.

Note that complete masking of the true behavioral profile of the user will lead the social media platform to recommend and push content data 312 that is of little to no interest to the user. For instance, obfuscation data 412 may lead the social media platform to falsely believe that the user is passionately interested in bowling. In some embodiments, the user may set configuration parameter(s) 410 to select between a ‘maximum feature mode’ a ‘maximum privacy mode,’ as described below. Note that any number of intermediary modes that combine these two approaches are also possible.

In general, the maximum feature mode may operate to allow through content data 312 for presentation to the user that the user wishes to see, while filtering out content data 312 that the user does not. AI defender process 248 may, for instance, do so to filter out content data 312 that results from obfuscation data 412. For example, assume that the user specifies via configuration parameter(s) 410 that she is interested in golf, but has no interest in bowling. In such a case, obfuscation module 406 may send obfuscation data 412 indicative of the user liking bowling to the social media platform. In response, when learning module 402 detects the social media platform sending bowling-related content data 312, it may filter out this content from presentation to the user.

As would be appreciated, the selected mode of operation of AI defender process 248 may affect how learning module 402 observes and learns. In some embodiments, if AI defender process 248 is in its maximum feature mode, learning module 402 may itself generate and maintain its own behavioral model of the user of the social media platform. For instance, learning module 402 may train its behavioral model using a set of predefined topical categories, to classify the behavior of the user. As the user clicks through links, makes posts, or otherwise interacts with the social media platform, learning module 402 may classify the resulting interaction data 310 to determine how the activity of the user should be classified (e.g., using an ANN, InfoGAN, Isolation Forest, etc.), Over time, learning module 402 may learn the behaviors of the user with increasing accuracy. This enables AI defender process 248 to filter content data 312 regarding topics of no interest to the user and tailor obfuscation data 412 towards these topics.

Once learning module 402 has sufficiently trained a behavioral model for the user, it may begin analyzing content data 312 pushed by the social media platform. Learning module 402 may also use this model to classify and categorize the pushed content data 312. At first, it is expected that the pushed content data 312 will have little correlation to the local user and will have a high degree of randomness (entropy). Over time, however, as the social media platform learns the user's behavior, the entropy (randomness) of the social media pushed content will go down. Learning module 402 can measure this entropy through the use of a simple classifier, such as a Naïve Bayes classifier or the like. A reduction in entropy over time indicates the social media platform is learning the user's behavior and is now targeting them in a specific way. In other words, learning module 402 may assess the entropy between interaction data 310 and content data 312 to identify when the behavioral model of the user maintained by the social media platform has converged. The user may or may not want this, which is why the level of warning and masking by AI defender process 248 may be configurable via configuration parameter(s) 410.

As the entropy metric declines, obfuscation module 406 may begin sending obfuscation data 412 to the social media platform, based on a configurable threshold set by the user via configuration parameter(s) 410. As this happens, it is expected that the entropy level will rise, indicating that the social media platform is no longer learning the true behavior of the user. Consequently, this becomes a closed-loop system where entropy level becomes a key performance indicator (KPI) governed by the desired entropy level set via configuration parameters) 410. One of the main benefits of the maximum feature mode is that learning module 402 also learning the behavioral profile of the user allows learning module 402 to filter out content data 312 that is of little to no interest to the user.

At the opposite end of the spectrum, AI defender process 248 may also support a maximum privacy model that may be set via configuration parameter(s) 410. In this mode, learning module 402 may assess interaction data 310 indicative of the actions of the user with respect to the social media platform (e.g., clicks, likes, dwell times, etc.), but does not permanently profile the behavior of the user. Thus, the only permanent profiling of the user is done by the social media platform, in this mode. Using a trained classifier (e.g., an ANN, etc.), learning module 402 may categorize the types of content with which the user interacts and then classify the content data 312 sent in response by the social media platform. As in the case of the maximum feature mode, learning module 402 may again leverage a pre-defined set of classes/topics (e.g., politics, sports, music, etc.).

In either mode, learning module 402 may model the associations and relationships between the actions of the user and the content sent in response by the social media platform. However, in the maximum privacy mode, long term storage of the actions of the user will not occur, so as to avoid having the user profiled by AI defender process 248. Indeed, some users may prefer not to have any AI profile them, even if it is done by AI defender process 248.

Learning module 402 may operate in a similar manner in maximum privacy mode as in maximum feature mode, with respect to learning and predicting how the social media platform will react to different interaction data 310. For instance, learning module 402 may use any of various forms of AI to classify content data 312 pushed by the social media platform. As the pushed content data 312 exceeds thresholds for randomness and has a high degree of entropy, learning module 402 may initiate various actions, such as alerting module 404 sending alerts 408 to the user, obfuscation module 406 sending obfuscation data 412 to the social media platform, etc., depending on configuration parameter(s) 410 set by the user.

Unlike in the maximum feature mode, learning module 402 may not be able to filter out content data 312 that is not of interest to the user, when in its maximum privacy mode. This is because learning module 402 will not maintain its own behavioral profile of the user, so as to distinguish between content data 312 of interest to the user and content data 312 that is not, such as content data 312 that results from obfuscation module 406 sending obfuscation data 412 to the social media platform. Consequently, the user may have to manually skip or ignore the content that is of little to no interest to them. For some users, this may be an acceptable tradeoff, to maximize their privacy. Note, however, that some filtering may still be possible in this mode through the setting of manual filters via configuration parameter(s) 410, in some embodiments.

In further embodiments, AI defender process 248 may synchronize its operations across any number of user devices or cloud services. Indeed, a particular user may access a social media platform using a mixture of different endpoint devices, such as desktops, laptops, tablets, and mobile phones. Thus, AI defender process 248 may synchronize across all of these endpoint devices, such as via a central service in the cloud or in a peer-to-peer manner across the endpoint devices.

In cloud-hosted implementations, AI defender process 248 may also rely on information across multiple users of the social media platform, such as in an anonymized manner. For instance, AI defender process 248 may leverage 1-bit stochastic gradient descent (SGD) to train a global, shared model of learning module 402 for use across any number of different users. In such a case, the only data exchanged between the various endpoint devices and the global AI model may be gradient updates, as well as model weights. In the case of Deep Neural Networks, these internal model states and gradients operate very similarly to encryption, thereby ensuring the privacy of the users' data. By doing so, the global model of learning module 402 will have a much better view of how the AI of the social media platform operates, in order to better counter it. The clustering and classification tasks would therefore have a greater accuracy, closer to the ones this invention needs to attack.

In a further embodiment, the techniques herein can be applied not only to human users but also an AI system, so as to protect the system from being profiled by a predatory AI system. Just as social media AIs seek to influence and manipulate the behaviors of human users, a similar paradigm can be seen with a predatory AI trying to influence or exert control another AI.

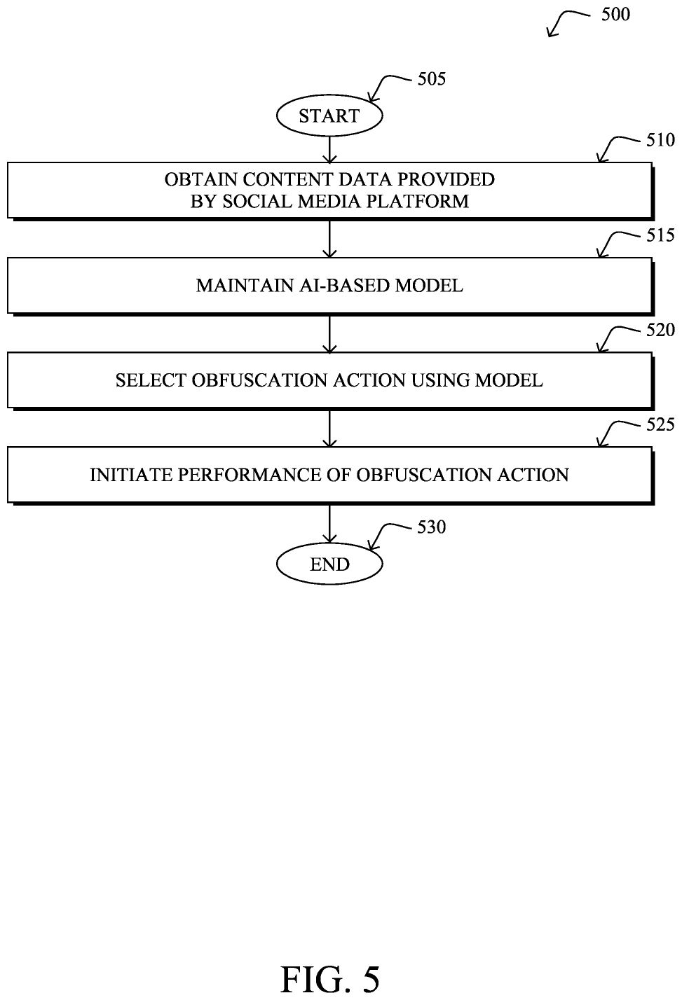

FIG. 5 illustrates an example simplified procedure for defending against the use of AI by a social media platform, in accordance with one or more embodiments described herein. For example, a non-generic, specifically configured device (e.g., device 200), such as an endpoint device, an intermediate device between an endpoint device and a social media platform, or the like, may perform procedure 500 by executing stored instructions (e.g., AI defender process 248). The procedure 500 may start at step 505, and continues to step 510, where, as described in greater detail above, the device may obtain content data provided by a social media platform to a user of the platform. In some embodiments, the social media platform selects the content data for the user based on a behavioral model for the user.

At step 515, as detailed above, the device may maintain an artificial intelligence (AI)-based model that models associations between the content data and interaction data indicative of interactions between the user and the social media platform. For instance, the AI-based model may assess a degree of entropy associated with the content data, to determine whether the behavioral model of the user has converged. In another embodiment, the device may maintain the AI-based model by training it using content data and interaction data associated with a plurality of users of the social media platform. By generating such a global model, the device may better predict how the social media platform will react to different types of interactions with the platform.

At step 520, the device may select, using the artificial intelligence-based model, an obfuscation action to lower an accuracy of the behavioral model of the user, as described in greater detail above. In various embodiments, the device may do so based on one or more configuration parameters set by the user. For instance, the one or more configuration parameters may control whether the artificial intelligence-based model comprises a second behavioral model of the user, the second behavioral model being based on the interaction data and configured to predict interactions between the user and the social media platform.

At step 525, as detailed above, the device may initiate performance of the obfuscation action. In some embodiments, the obfuscation action may entail the user clearing a cache or resetting an advertising identifier and the device may send an alert indicative of the action for review by the user. In other embodiments, this may entail the device sending false interaction data to the social media platform. In some embodiments, the false interaction data may cause the social media platform to send a particular type of content to the user. In such a case, the device may then filter the particular type of content from presentation to the user. In further instances, the device may also provide information regarding the behavioral model of the user to a user interface, so as to allow the user to review how the social media platform has profiled the user. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a social media AI defense mechanism that is able to identify threats and warn a user about tactics and manipulation that is being attempted by the social media AI. In another aspect, the techniques herein are able to mask the true behaviors of user so that the social media AI cannot effectively profile the user. Both the level of warnings and the masking may be user configurable, to allow the user to dial in an exact amount of intervention by the defender. When high levels of masking/obfuscation are enabled, the defender may enter a maximum feature mode that can strip out the content noise from the Social Media AI, so that the user has the same social media experience but, at the same time, is not able to be accurately profiled by the social media AI. In further aspects, the defender may also have a maximum privacy mode to bypass profiling the local user while still providing a full defense against a social media AI. In addition, the techniques herein are flexible and can be deployed fully locally on the endpoint device of the user, at an intermediate location (e.g., in the cloud), or both.

While there have been shown and described illustrative embodiments that provide for defending against AI profiling of a user by a social media platform, it is to be understood that various other adaptations and modifications may be made within the spirit and scope of the embodiments herein. For example, while certain embodiments are described herein with respect to using certain models for purposes of initiating obfuscation actions against the profiling of a user, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, content data provided by a social media platform to a user of the social media platform, wherein the social media platform selects the content data for the user based on a behavioral model of the user;
maintaining, by the device, an artificial intelligence-based model that models associations between the content data and interaction data indicative of interactions between the user and the social media platform;
selecting, by the device and using the artificial intelligence-based model, an obfuscation action to lower an accuracy of the behavioral model of the user, based on one or more configuration parameters set by the user; and
initiating, by the device, performance of the obfuscation action.

2. The method as in claim 1, wherein the device is an intermediary between the social media platform and an endpoint operated by the user.

3. The method as in claim 1, wherein the obfuscation action comprises the user clearing a cache or resetting an advertising identifier, and wherein initiating performance of the obfuscation action comprises:
sending an alert indicative of the obfuscation action for review by the user.

4. The method as in claim 1, wherein the one or more configuration parameters controls whether the artificial intelligence-based model comprises a second behavioral model of the user, the second behavioral model being based on the interaction data and configured to predict interactions between the user and the social media platform.

5. The method as in claim 1, wherein performance of the obfuscation action comprises:
sending false interaction data to the social media platform.

6. The method as in claim 5, wherein the false interaction data causes the social media platform to send a particular type of content to the user, and wherein the method further comprises:
filtering the particular type of content from presentation to the user.

7. The method as in claim 1, wherein the device is an endpoint device operated by the user.

8. The method as in claim 1, wherein the artificial intelligence-based model assesses a degree of entropy associated with the content data to determine whether the behavioral model of the user has converged.

9. The method as in claim 1, wherein maintaining the artificial intelligence-based model comprises:
training the artificial intelligence-based model using content data and interaction data associated with a plurality of users of the social media platform.

10. The method as in claim 1, further comprising:
providing information regarding the behavioral model of the user to a user interface.

11. An apparatus, comprising:
one or more network interfaces;
a processor coupled to the one or more network interfaces and configured to execute one or more processes; and
a memory configured to store a process that is executable by the processor, the process when executed configured to:
obtain content data provided by a social media platform to a user of the social media platform, wherein the social media platform selects the content data for the user based on a behavioral model of the user;
maintain an artificial intelligence-based model that models associations between the content data and interaction data indicative of interactions between the user and the social media platform;
select, using the artificial intelligence-based model, an obfuscation action to lower an accuracy of the behavioral model of the user, based on one or more configuration parameters set by the user; and
initiate performance of the obfuscation action.

12. The apparatus as in claim 11, wherein the apparatus is an intermediary between the social media platform and an endpoint operated by the user.

13. The apparatus as in claim 11, wherein the obfuscation action comprises the user clearing a cache or resetting an advertising identifier, and wherein the apparatus initiates performance of the obfuscation action by:
sending an alert indicative of the obfuscation action for review by the user.

14. The apparatus as in claim 11, wherein the one or more configuration parameters controls whether the artificial intelligence-based model comprises a second behavioral model of the user, the second behavioral model being based on the interaction data and configured to predict interactions between the user and the social media platform.

15. The apparatus as in claim 11, wherein performance of the obfuscation action comprises:
sending false interaction data to the social media platform.

16. The apparatus as in claim 15, wherein the false interaction data causes the social media platform to send a particular type of content to the user, and wherein the process when executed is further configured to:
filter the particular type of content from presentation to the user.

17. The apparatus as in claim 11, wherein the apparatus is an endpoint device operated by the user.

18. The apparatus as in claim 11, wherein the artificial intelligence-based model assesses a degree of entropy associated with the content data to determine whether the behavioral model of the user has converged.

19. The apparatus as in claim 11, wherein the process when executed is further configured to:
provide information regarding the behavioral model of the user to a user interface.

20. A tangible, non-transitory, computer-readable medium storing program instructions that cause a device to execute a process comprising:
obtaining, by the device, content data provided by a social media platform to a user of the social media platform, wherein the social media platform selects the content data for the user based on a behavioral model of the user;
maintaining, by the device, an artificial intelligence-based model that models associations between the content data and interaction data indicative of interactions between the user and the social media platform;
selecting, by the device and using the artificial intelligence-based model, an obfuscation action to lower an accuracy of the behavioral model of the user, based on one or more configuration parameters set by the user; and
initiating, by the device, performance of the obfuscation action.
